(19) United States
(12) Patent Application Publication
(10) Pub. No.: US 2009/0001045 A1
(43) Pub. Date: Jan. 1, 2009

(54) METHODS OF PATTERNING SELF-ASSEMBLY NANO-STRUCTURE AND FORMING POROUS DIELECTRIC

(75) Inventors: Kuang-Jung Chen, Poughkeepsie, NY (US); Wai-Kin Li, Beacon, NY (US); Haining S. Yang, Wappingers Falls, NY (US)

Correspondence Address: HOFFMAN WARNICK LLC, 75 STATE ST, 14TH FL, ALBANY, NY, 12207, US

(73) Assignee: INTERNATIONAL BUSINESS MACHINES CORPORATION, Armonk, NY (US)

(21) Appl. No.: 11/769,126

(22) Filed: Jun. 27, 2007

(51) Int. Cl. H01B 13/00

(52) U.S. Cl. 216/13; 977/888

(57) ABSTRACT

Methods of patterning a self-assembly nano-structure and forming a porous dielectric are disclosed. In one aspect, the method includes providing a hardmask over an underlying layer; predefining an area with a photoresist on the hardmask that is to be protected during the patterning; forming a layer of the copolymer over the hardmask and the photoresist; forming the self-assembly nano-structure from the copolymer; and etching to pattern the self-assembly nano-structure.

### BACKGROUND

1. Technical Field

The disclosure relates generally to integrated circuit (IC) chip fabrication, and more particularly, to methods of patterning a self-assembly nano-structure used for forming a porous dielectric and methods of forming the porous dielectric.

2. Background Art

In the integrated circuit (IC) chip fabrication industry, back-end-of-line (BEOL) interconnects have been the target of modifications to minimize circuit delay. One approach to reduce circuit delay has been to convert from the conventional silicon dioxide (SiO₂) dielectric (dielectric constant (k) of approximately 3.9) to dense low-k material (k<3.0) such as hydrogenated silicon oxycarbide (SiCOH). For further performance improvement, more parasitic capacitance reduction is required (e.g., k<2.5) for high speed circuits.

Lowering parasitic capacitance can be achieved with new porous low-k dielectrics such as self-assembly nano-structures. However, most of the porous materials have relatively weak mechanical properties compared to denser dielectrics. Integration of the porous low-k dielectrics with other processes also presents a challenge. For example, conventional chemical mechanical polishing (CMP) is commonly used to planarize materials. CMP, however, presents a number of difficulties relative to polishing porous low-k dielectrics. In another example, conventional physical vapor deposition (PVD) of diffusion barrier layers cannot adequately fill pores and cover a surface of a porous dielectric.

One approach to the above issues has been to physically remove the self-assembly nano-structure from the interlevel dielectric (ILD) layers. As shown in FIGS. 1-3, typically, a copolymer mixture 10 consisting of polystyrene (PS) and poly(methyl-metacrylate)(PMMA) is applied to a surface 12, e.g., over a hardmask 14 over a dielectric underlayer 16 (e.g., spin-on organic polymer) over a silicon substrate 18. As shown in FIG. 2, an anneal causes a micro-phase segregation of the block components, resulting in the PS block polymer 20 being re-arranged to form a rectangular pattern that is interspersed with columns of PMMA 22. PMMA columns 22 are then selectively removed by wet or dry etch, which also patterns hardmask 14 that is later used to form a porous dielectric 24 (FIGS. 6-7). As shown in FIG. 3, a region 26 may be protected from removal by a conventional patterned photoresist 28 on top of PS 20 and PMMA 22. Unfortunately, as shown in FIGS. 4-5, during the plasma process to remove PMMA 22 from PS 20 (FIGS. 6-7), photoresist 28 deposits back on top of PS 20, preventing removal of PMMA 22 and/or filling pores 30. FIG. 5 shows a top view of FIG. 4. Consequently, as shown in FIGS. 6-7, the pattern in hardmask 14 and thus porous dielectric 24 may be non-uniform, which decreases performance improvements.

### SUMMARY

Methods of patterning a self-assembly nano-structure and forming a porous dielectric are disclosed. In one aspect, the method includes providing a hardmask over an underlying layer; predefining an area with a photoresist on the hardmask that is to be protected during the patterning; forming a layer of the copolymer over the hardmask and the photoresist; forming the self-assembly nano-structure from the copolymer; and etching to pattern the self-assembly nano-structure.

A first aspect of the disclosure provides a method of patterning a self-assembly nano-structure formed using a copolymer, the method comprising: providing a hardmask over an underlying layer; predefining an area with a photoresist on the hardmask that is to be protected during the patterning; forming a layer of the copolymer over the hardmask and the photoresist; forming the self-assembly nano-structure from the copolymer; and etching to pattern the self-assembly nano-structure.

A second aspect of the disclosure provides a method of forming a porous dielectric layer, the method comprising: providing a hardmask over an underlying dielectric layer; predefining an area with a photoresist on the hardmask that is to be protected during patterning; forming a layer of a self-assembly di-block copolymer over the hardmask and the photoresist; forming a self-assembly nano-structure from the self-assembly diblock copolymer; etching to pattern the self-assembly nano-structure and to pattern the hardmask; removing the self-assembly nano-structure and the photoresist; and etching to pattern the underlying dielectric layer using the hardmask.

A third aspect of the disclosure provides a method of forming a porous dielectric layer, the method comprising: providing a hardmask over an underlying dielectric layer; predefining an area with a photoresist on the hardmask that is to be protected during patterning; forming a layer of a self-assembly di-block copolymer over the hardmask and the photoresist, the photoresist being insoluble in the di-block copolymer; annealing to cause a micro-phase segregation of the self-assembly di-block copolymer to form a self-assembly nano-structure; etching to pattern the self-assembly nano-structure and to pattern the hardmask; removing the self-assembly nano-structure and the photoresist; and etching to pattern the underlying dielectric layer using the hardmask.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIGS. 1-7 show a conventional patterning and porous dielectric forming process.

FIGS. 8-15 show embodiments of methods of patterning a self-assembly nano-structure and forming a porous dielectric according to the disclosure.

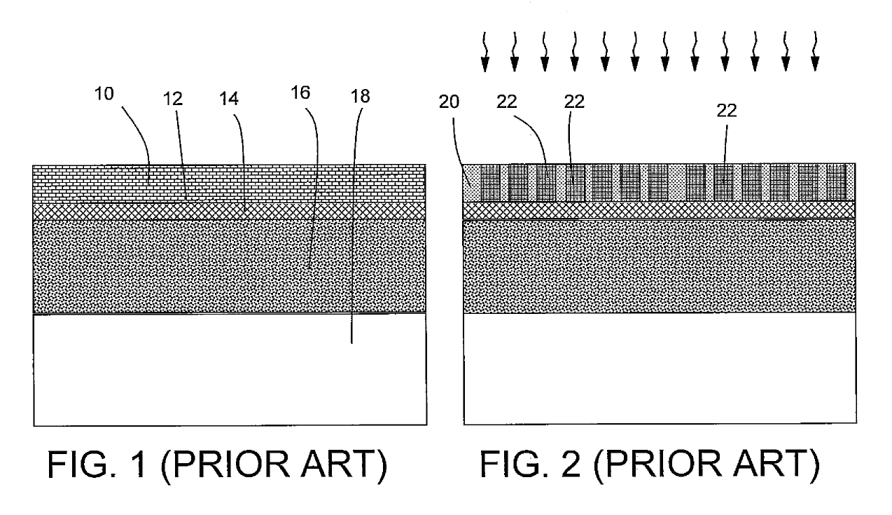

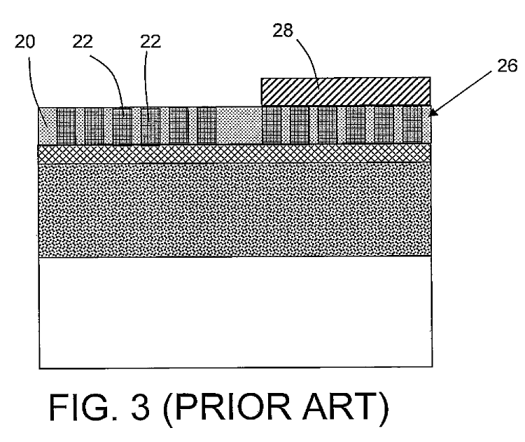

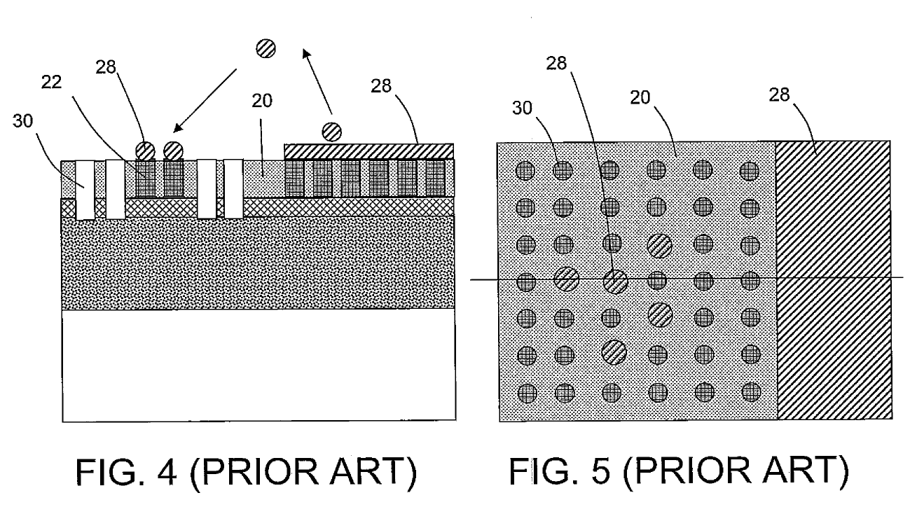

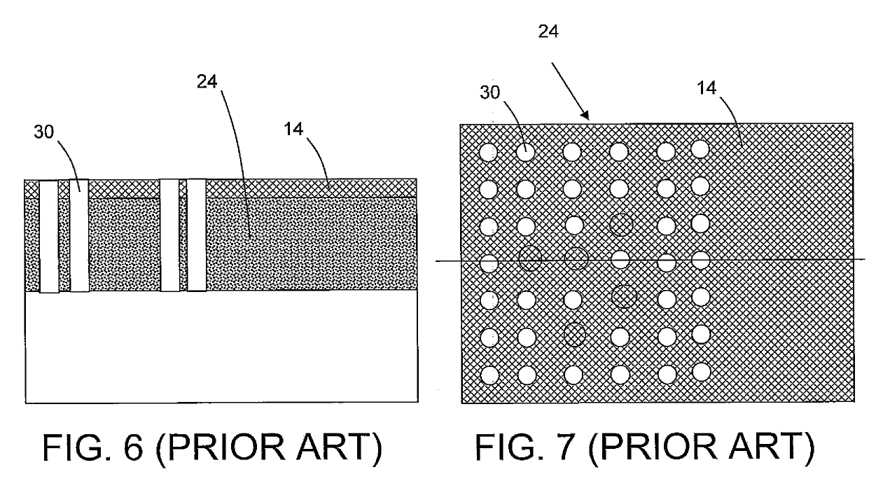

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION

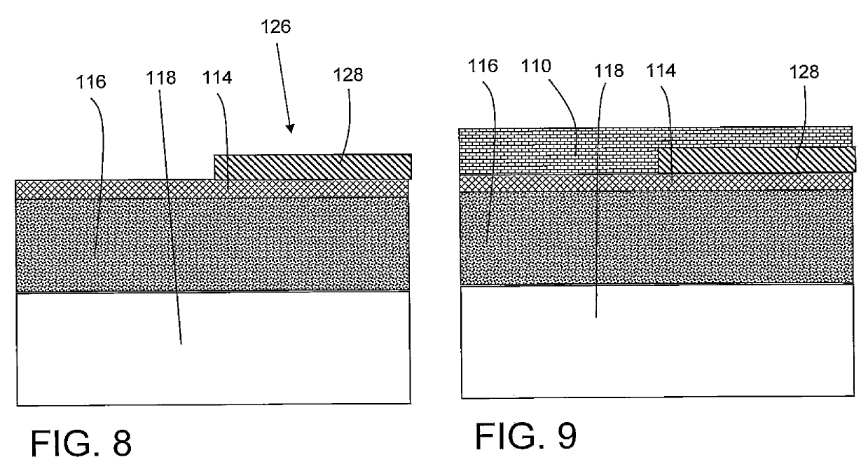

FIGS. 8-15 show embodiments of methods of patterning a self-assembly nano-structure and forming a porous dielectric according to the disclosure. FIG. 8 shows providing a hardmask 114 over an underlying layer 116, the latter of which may include a dielectric to be formed into a porous dielectric. Underlying layer 116 may include any now known or later developed dielectric or low dielectric constant (low-k) material (k<3.9) that may be converted to a porous dielectric material. For example, underlying dielectric layer 116 may be a spin-on organic polymer, hydrogenated silicon oxycarbide (SiCOH), silicon nitride (Si₃N₄), silicon dioxide (SiO₂), SiLK® (manufactured by Dow Chemical Co., Midland, Mich.). Underlying layer 116 may be formed over a substrate 118, e.g., a silicon substrate or other integrated circuit (IC) chip layer upon which a porous dielectric is used.

FIG. 8 also shows predefining an area 126 with a photoresist 128 on hardmask 114 that is to be protected during (subsequent) patterning. Photoresist 128 is insoluble in a self-assembly di-block copolymer 110 (FIG. 9) such that it is not harmed when copolymer 110 (FIG. 9) is formed thereover. In addition, photoresist 128 must be able to withstand an anneal for copolymer 110 without deforming and must be able to withstand an etching solvent for a material to be removed from the self-assembly nano-structure resulting from copolymer 110. With regard to the latter requirement, photoresist 128 may be insoluble in, for example, propylene glycol methyl ether acetate (PGMEA).

FIG. 9 shows forming a layer of copolymer 110 over hardmask 114 and photoresist 128. Copolymer 110 may be formed using any now known or later deposition technique, for example: chemical vapor deposition (CVD), low-pressure CVD (LPCVD), plasma-enhanced CVD (PECVD), semi-atmosphere CVD (SACVD) and high density plasma CVD (HDPCVD), rapid thermal CVD (RTCVD), ultra-high vacuum CVD (UHVCVD), limited reaction processing CVD (LRPCVD), metalorganic CVD (MOCVD), sputtering deposition, ion beam deposition, electron beam deposition, laser assisted deposition, spin-on methods, physical vapor deposition (PVD), atomic layer deposition (ALD), chemical oxidation, molecular beam epitaxy (MBE), plating and evaporation. Copolymer 110 may include any now known or later developed self-assembly diblock copolymer, e.g., polystyrene-block-polymethylmethacrylate (PS-b-PMMA), polystyrene-block-polyisoprene (PS-b-PI), polystyrene-block-polybutadiene (PS-b-PBD), polystyrene-block-polyvinylpyridine (PS-b-PVP), polystyrene-block-polyethyleneoxide (PS-b-PEO), polystyrene-block-polyethylene (PS-b-PE), polystyrene-b-polyorganosilicate (PS-b-POS), polystyrene-block-polyferrocenyldimethylsilane (PS-b-PFS), polyethyleneoxide-block-polyisoprene (PEO-b-PI), polyethyleneoxide-block-polybutadiene (PEO-b-PBD), polyethyleneoxide-block-polymethylmethacrylate (PEO-b-PMMA), polyethyleneoxide-block-polyethylethylene (PEO-b-PEE), polybutadiene-block-polyvinylpyridine (PBD-b-PVP), and polyisoprene-block-polymethylmethacrylate (PI-b-PMMA). Alternatively, a tri-block copolymer may also be employed. For purposes of brevity, use of polystyrene-block-polymethylmethacrylate (PS-b-PMMA) will be described herein. It is understood that the teachings of the disclosure may be applied to the other copolymers listed.

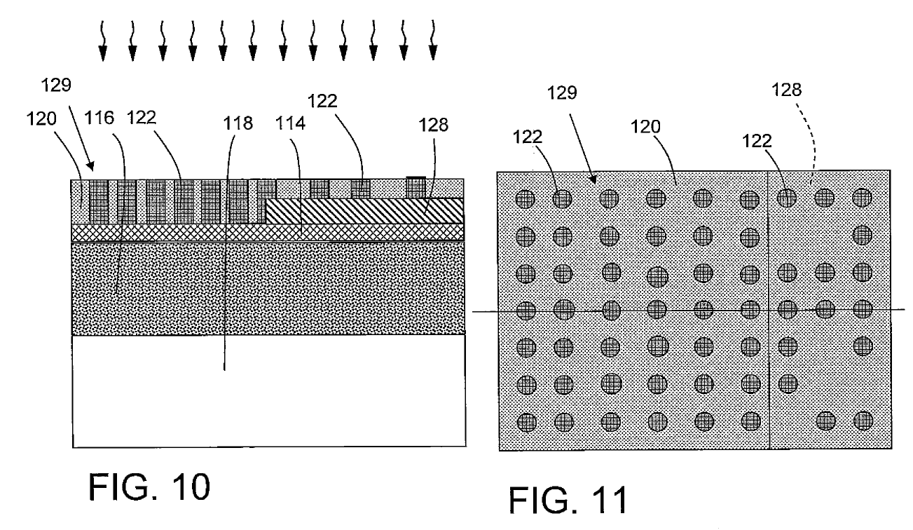

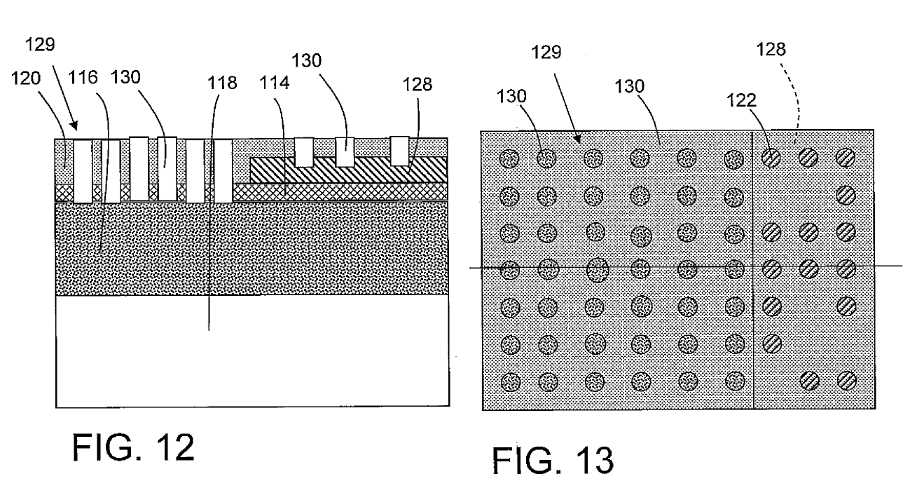

FIGS. 10-11 show forming a self-assembly nano-structure 129 from copolymer 110 (FIG. 9). In one embodiment, this process includes annealing (e.g., at approximately 200° C.) to cause a micro-phase segregation of copolymer 110 (FIG. 9) into polystyrene 120 and PMMA columns 122. FIG. 11 shows a top view of FIG. 10 illustrating how some of PMMA columns 122 may not form over photoresist 128. Although, PMMA columns 122 and resulting pores 130, 132 (FIGS. 12-15) are shown in a substantially uniformly distributed manner, it is understood that the distribution may not be as perfectly dispersed as illustrated.

FIGS. 12-13 show etching to pattern self-assembly nano-structure 129. The etching may use any of the above-described solvents, e.g., PGMEA, in which photoresist 128 is insoluble. As shown, the etching patterns self-assembly nano-structure 129 by removing PMMA columns 122 (FIGS. 10-11) from polystyrene 120, leaving pores 130. Pores 130 over photoresist 128 penetrate at most only partially through photoresist 128, while pores 130 over hardmask 114 extend through hardmask 114 to pattern it, i.e., they penetrate to underlying layer 116. Since photoresist 128 is insoluble in the etching solvent, it does not deposit back on top of PMMA 122 (FIGS. 10-11), thus the full distribution of pores 130 are transferred to hardmask 114.

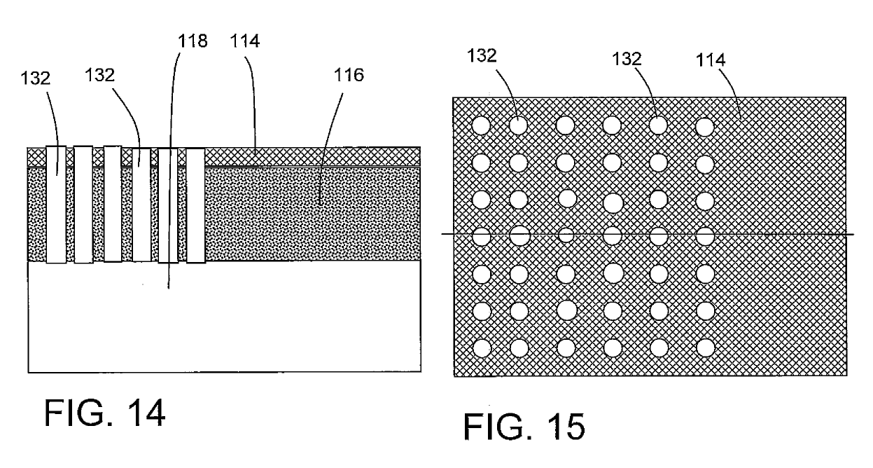

FIGS. 14-15 show patterning underlying layer 116 by removing photoresist 128 (FIGS. 12-13) and etching to pattern underlying layer 116 using hardmask 114, i.e., extend pores 130 in hardmask 114 to form pores 132 in underlying layer 116 to make it porous. The etching may include using any now known or later developed etching recipe for removing underlying layer 116, e.g., a reactive ion etch (RIE) or wet etch.

The methods as described above are used in the fabrication of integrated circuit chips. The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The foregoing description of various aspects of the disclosure has been presented for purposes of illustration and description. It is not intended to be exhaustive or to limit the disclosure to the precise form disclosed, and obviously, many modifications and variations are possible. Such modifications and variations that may be apparent to a person skilled in the art are intended to be included within the scope of the disclosure as defined by the accompanying claims.

1.-20. (canceled)

21. A method of forming a porous dielectric layer, the method comprising:
providing a hardmask over an underlying dielectric layer;
predefining an area with a photoresist on the hardmask that is to be protected during patterning;
forming a layer of a self-assembly di-block copolymer over the hardmask and the photoresist, wherein the photoresist being insoluble in the di-block copolymer and the di-block copolymer includes polystyrene having poly(methyl-metacrylate)(PMMA) columns therein;
annealing to cause a micro-phase segregation of the self-assembly di-block copolymer to form a self-assembly nano-structure;
etching to pattern the self-assembly nano-structure and to pattern the hardmask including removing the PMMA columns from the polystyrene, wherein the photoresist is insoluble in a solvent used during the etching to pattern the self-assembly nano-structure;
removing the self-assembly nano-structure and the photoresist; and
etching to pattern the underlying dielectric layer using the hardmask.
